(19) United States
(12) Patent Application Publication
(10) Pub. No.: US 2010/0318815 A1
(43) Pub. Date: Dec. 16, 2010

(54) POWER SUPPLY CIRCUIT FOR AUDIO CODEC CHIP

(75) Inventor: KE-YOU HU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/557,532

(22) Filed: Sep. 11, 2009

(30) Foreign Application Priority Data
Jun. 12, 2009 (CN) 200910303217.9

(51) Int. Cl. G06F 1/26

(52) U.S. Cl. 713/300

(57) ABSTRACT

A power supply circuit for an audio codec chip includes a power supply output terminal configured for providing a working voltage for the audio codec chip, a first filter circuit, a regulator circuit, and a second filter circuit. The first filter circuit is coupled to the power supply output terminal. The regulator circuit has an input terminal and an output terminal. The regulator circuit input terminal is connected to the first filter circuit. The second filter circuit is connected to the regulator circuit output terminal, and is coupled to a power source input terminal of the audio codec chip.

### BACKGROUND

1. Technical Field

The present disclosure relates to power supply circuits, and particularly to a power supply circuit for an audio codec chip.

2. Description of Related Art

In computer systems, power supplies are connected to motherboards. A motherboard includes a power output terminal for providing power to different elements on the motherboard, for example, an audio codec chip. The power output terminal will output a direct current (DC) working voltage to the audio codec chip. Generally, an alternating current (AC) voltage component called a ripple voltage, will be output with the DC working voltage to the audio codec chip. However, if the ripple voltage is over a limited value, the audio codec chip will generate noise, thereby affecting output signal quality.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a diagram of an embodiment of a power supply circuit for an audio codec chip.

FIG. 2 is a circuit diagram of the power supply circuit of FIG. 1.

### DETAILED DESCRIPTION

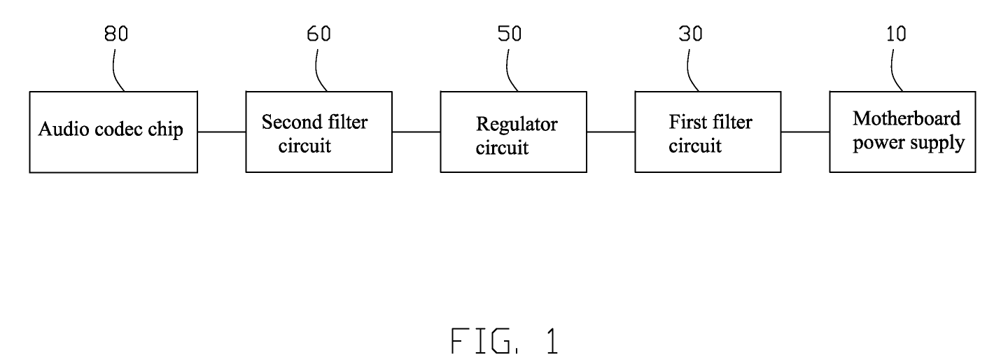

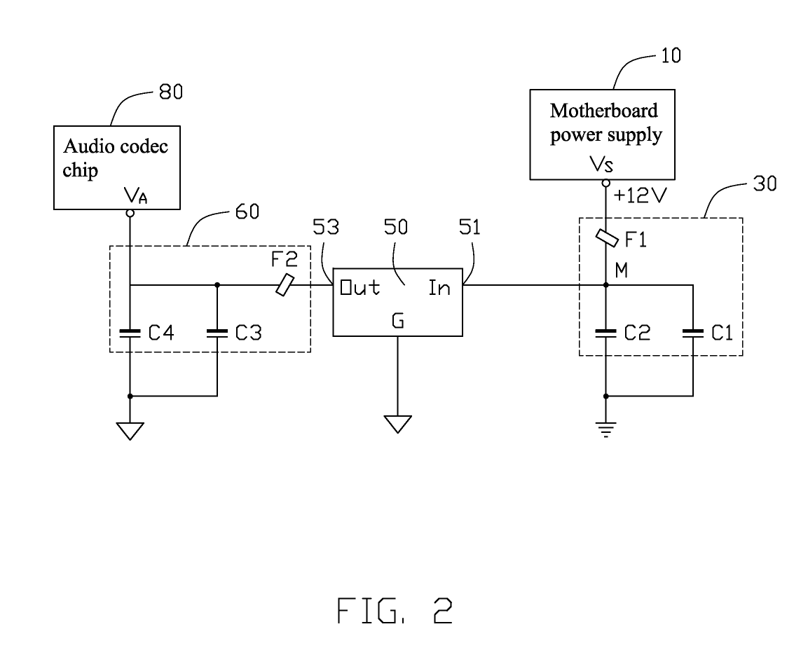

Referring to FIGS. 1 and 2, an embodiment of a power supply circuit for an audio codec chip 80 includes a motherboard power supply 10, a first filter circuit 30, a regulator circuit 50, a second filter circuit 60, and a power input terminal V_{A} of the audio codec chip 80. The regulator circuit 50 is connected to the motherboard power supply 10 via the first filter circuit 30, and connected to the power source input terminal V_{A} via the second filter circuit 60.

The motherboard power supply 10 includes an output terminal V_{S} capable of outputting a 12V voltage. The first filter circuit 30 includes a first bead inductor F1 coupled to the motherboard power source output terminal V_{S}, a first capacitor C1, and a second capacitor C2. The first capacitor C1 is coupled to the second capacitor C2 in parallel. One common end of the first capacitor C1 and the second capacitor C2 is grounded, and the other common end is coupled to the first bead inductor F1. As an example, a capacitance value of the first capacitor C1 may be 10 μF, a capacitance value of the second capacitor C2 may be 0.1 μF, and an impedance value of the first bead inductor F1 may be 80 ohm. Also, the capacitance value of the first capacitor C1, the capacitance value of the second capacitor C2, and the impedance value of the first bead inductor F1 may be other values if they satisfy the requirements of the purpose of the present embodiment.

The regulator circuit 50 has an input terminal 51, an output terminal 53, and a ground terminal G. The regulator circuit input terminal is coupled to a common node M of the first bead inductor F1, the first capacitor C1, and a second capacitor C2. The regulator circuit type may be, for example, L78L05, or other similar type.

The second filter circuit 60 includes a second bead inductor F2, a third capacitor C3, and a fourth capacitor C4. The third capacitor C3 and the fourth capacitor C4 are connected in parallel, and one common end of the third capacitor C3 and the fourth capacitor C4 is grounded, the other common end is coupled to the regulator circuit output terminal 53 and the power source input terminal V_{A} of the audio codec chip 80. A capacitance value of the third capacitor C3 may be 10 μF, a capacitance value of the fourth capacitor C4 may also be 0.1 F, and an impedance value of the second bead inductor F1 may be 100 ohm. Also, the capacitance value of the third capacitor C3, the capacitance value of the second capacitor C4, and the impedance value of the second bead inductor F2 may be other values if they satisfy the requirements of the purpose of the present embodiment.

When the power supply circuit is in use, the motherboard power supply 10 outputs 12V DC. The 12V flows through the first filter circuit 30 and is regulated to 5V by the regulator circuit 50. The 5V is filtered by the second filter circuit 60 and then is sent to the audio codec chip power source input terminal V_{A}. During this process, a ripple signal output with the DC power source voltage will be filtered out by the first filter circuit 30 and the second filter circuit 60, thereby preventing the ripple signal from affecting signal output quality of the audio codec chip 80.

It is to be understood, however, that even though numerous characteristics and advantages of the embodiments have been set forth in the foregoing description, together with details of the structure and function of the present disclosure, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A power supply circuit for an audio codec chip, comprising:
a power supply output terminal configured for providing a working voltage for the audio codec chip;
a first filter circuit coupled to the power supply output terminal;
a regulator circuit having an input terminal and an output terminal, the regulator circuit input terminal coupled to the first filter circuit; and
a second filter circuit connected to the regulator circuit output terminal, and coupled to a power source input terminal of the audio codec chip.

2. The power supply circuit of claim 1, wherein the first filter circuit comprises a first bead inductor, a first capacitor and a second capacitor, the first capacitor and the second capacitor are connected in parallel, and are coupled to the power supply output terminal via the first bead inductor.

3. The power supply circuit of claim 2, wherein the regulator circuit is coupled to a common node of the first bead inductor, the first capacitor, and the second capacitor.

4. The power supply circuit of claim 2, wherein a capacitance value of the first capacitor is 10 μF, and a capacitance value of the second capacitor is 0.1 μF.

5. The power supply circuit of claim 2, wherein an impedance value of the first bead inductor is 80 ohm.

6. The power supply circuit of claim 1, wherein the second filter circuit comprises a second bead inductor, a third capacitor and a fourth capacitor, the third capacitor and the fourth capacitor are connected in parallel; the second bead inductor has two terminals, one terminal is coupled to the regulator circuit output terminal, and the other terminal is coupled to the power source input terminal of the audio codec chip.

7. The power supply circuit of claim 6, wherein an impedance value of the second bead inductor is 100 ohm.

8. The power supply circuit of claim 6, wherein a capacitance value of the third capacitor is 0.1 μF, and a capacitance value of the fourth capacitor is 0.1 μF.
